(19) United States
(12) Patent Application Publication
(10) Pub. No.: US 2006/0241983 A1
(43) Pub. Date: Oct. 26, 2006

(54) Customer centric travel system

(76) Inventors: Valerie Viale, Nice (FR); Vincent Lextrait, Nice (FR)

Correspondence Address: YOUNG & THOMPSON, 745 SOUTH 23RD STREET, 2ND FLOOR, ARLINGTON, VA, 22202, US

(21) Appl. No.: 11/110,870

(22) Filed: Apr. 21, 2005

(51) Int. Cl. G06Q 10/00

(52) U.S. Cl. 705/5

(57) ABSTRACT

A customer-centric travel information management system includes one user record dedicated to each travel user, a user information storage area configured to store information release authorizations, personal request information, information input into the user information storage area for transmission to the user, and a user identification; a user interface; a customer profiles database; and plural travel segment records, each travel segment record including travel segment data generated by a specific travel provider, a trigger generating provider notice information upon changes in the travel segment data, and a user notification information section generating user notification information upon changes in the travel segment data by the specific travel provider.

### BACKGROUND OF THE INVENTION

The present invention concerns a customer-centric travel information management approach embodied as a travel industry system that enables travelers (“customers”) to centrally master and manage information concerning themselves so that disparate travel industry service providers (“providers”) can in turn provide enhanced travel experiences by allowing, increasing, and maximizing customer relationship management, inventories management, and revenue management.

The inventive system first allows customers and providers to act as information contributors to a central database where contributors independently provide travel information to the central database. The inventive system second allows the thus-centralized information to be available, on a restricted basis, to each contributor (customers and providers).

### DESCRIPTION OF THE RELATED ART

Traveler customers purchase travel products and services through many distribution channels. Each travel purchase results in a travel record being produced that reflects a certain number of travel segments. A travel segment may relate to a flight reservation, the specific request for that flight, a hotel reservation, a car rental reservation, a tour reservation, a frequent flyer card number, and customer profile information.

In the prior art, when considering the customer's entire travel plan, plural travel records are produced. For example, there is a travel record relating to the airline flight reservation, another travel record relating to the hotel reservation, and yet another travel record relating to the car rental.

Each provider has access to the travel record in which their product is stored, but no provider has an overall view of the customer's entire travel plan. This limitation inherently limits the degree to which any provider can react to the customer's changing needs. For example, if the hotel does not have access to the customer's flight travel record, the hotel is not in a position to release a traveler's room when the flight is cancelled or the customer is rebooked on a flight for the next day.

Prior art systems have fallen short of meeting these needs.

U.S. Published Application 2002-0087337, by Hensley, discloses a business system in which a travel broker maintains a customer database with records including customer information. The service providers, however, receive a reduced or redacted copy of the customer database that identifies the customers only by aliases, thereby ensuring the privacy of the customer information. While the Hensley system may allow providers to understand customers' needs in a general sense, the providers are not able to respond specifically to any single customer.

U.S. Published Application 2003-0225600, by Slivka et al., discloses re-accommodating passengers following a travel disruption by determining an impact of schedule changes on passenger flow and re-accommodate disrupted passengers using a value for a disrupted passenger based on selected criteria and rules that may be established by travel service providers.

Slivka et al. teach optimization (i.e., the efficient utilization) of provider assets using computer-based decision support systems to facilitate the planning of schedules, routes, aircraft and crew rotations, yield management, and passenger flow. Although individual customers are re-accommodated, there remains a need to address the preferences/requests of the individual customers.

There are prior art systems that attempt to address customer requests. For example, U.S. Pat. No. 6,009,408 discloses booking travel based on input criteria. U.S. Published Application 2003-0061145 provides a reservation system implemented via a plurality of Internet web sites. Each booking party is directed to a web site containing common content and content specific to the type of booking party, such as a travel agent, wholesaler, or traveler. Although progress has been made in making reservations, there remains a need for a system that acts independently and responsive to travel and customer situational changes.

### SUMMARY OF THE INVENTION

The invention addresses the need for a travel system that acts independently and responsive to travel and customer situational changes, taking into account the customer's preferences and requests.

The invention addresses the need to integrate travel segment information in a manner that enhances the customer's travel experience. For example, segment information concerning a customer's airline flight is useful to the hotel at which the customer has made a room reservation, since the hotel would like to automatically know if the customer's flight will be delayed or cancelled. In this case, the hotel can, independently of notification from the traveler, release the original room and rebook a new room that meets the customer's preferences and requests, e.g., a wheelchair accessible room.

The inventive system allows the various providers to access the customer's travel segment information in order to follow the customer through the customer's trip and thereby to provide an enhanced travel experience by adapting to the customer's changing needs during the customer's trip.

Customers participate in that the customers centrally master and manage information concerning themselves, their preferences, and their travel requests so that disparate travel industry service providers (“providers”) can in turn provide an enhanced travel experiences. Providers also independently participate in that travel segment information is contributed to a central database. The consolidation of customer and provider contribution results in a consolidated, real-time database reflective of the original travel plan and the customer's progress through that travel plan.

The thus-centralized and consolidated information is available, on a restricted basis, to each contributor (customers and providers) to allow automatic real time adjustments in the customer's travel experience. This system is a win-win for both the customers and the providers in that the customers have enhanced travel experiences and the providers, either directly or indirectly, having increased provider revenue.

For example, if the customer indicates a request to a vegetarian meal for their air flight, that information can be obtained by the hotel for use in more personalized accommodation and targeted marketing. Similar examples are provided concerning personal services (requests for bassinet, wheelchair, etc.). Additionally, the invention provides for automatic real-time adaptation of the customer's needs, e.g., new car reservations for flight re-routing and delayed arrival at a hotel for a late flight. Delayed flight information may be used to trigger additional sales that solicit customers, waiting for delayed flights, to dine at the airport restaurant or to shop at airport stores (text messages being sent to customers' PDAs or phones, including coupons or with airport infomation).

The invention is automated in responding to travel disruption events through the use of event triggers that cause a provider to be notified of an event occurring with respect to a customer's travel record, e.g., the flight being delayed or re-routed. These event triggers allow the provider to respond, automatically and independently of the customer, in an appropriate manner such as extending an offer to dine or revising a car reservation to a different type of vehicle taking in account new weather conditions. The consolidated information enables passing customer personal preferences/requests made to one provider to another disparate provider (meal types, wheelchair needs given to an airline is passed to hotel or car rental) so that the automatic action taken by the provider is tailored to the particular customer.

### BRIEF DESCRIPTION OF THE DRAWING

FIG. 1 depicts the inventive travel system including a database of user records.

### DESCRIPTION OF THE PREFERRED EMBODIMENTS

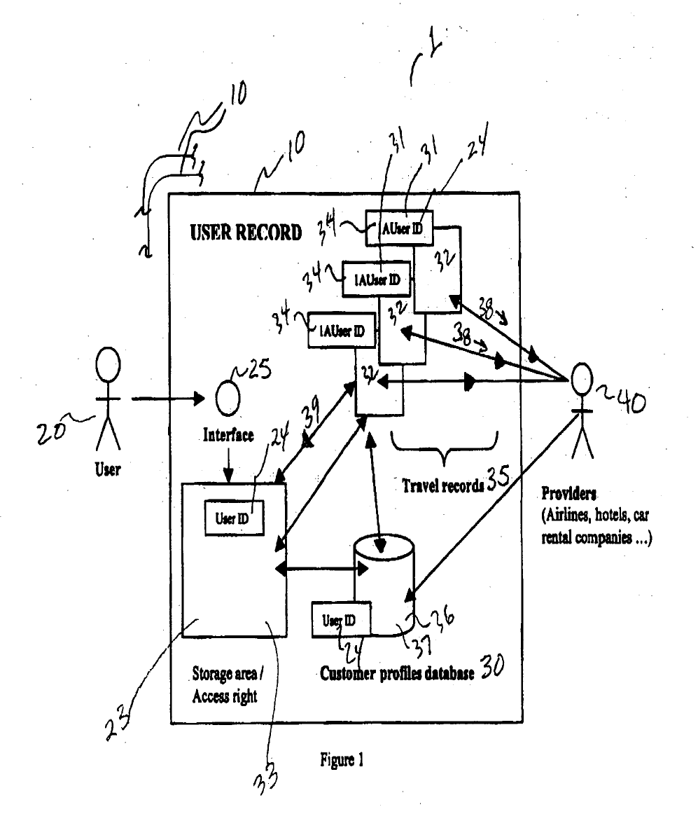

The inventive travel system 1 includes a database hosted in a global distribution system, e.g., a database accessible via the internet. The system's database 1 comprises a plurality of user records 10. Each user record 10 (FIG. 1) contains all the information concerning the user 20 such as travel segment records 35 and customer profiles.

The user 20 reflected in FIG. 10 represents one individual traveler customer. Each user has their own user record 10.

There is provided an interface 25 through which the user interacts with the system to enter customer profile information into a customer profiles database 30 and to make travel plans with plural providers 40. These travel plans that are made with the plural providers 40, e.g., flight, hotel, and car reservations, in turn generate travel segment records 34 stored within a travel records database 35.

The user record links the user's customer profile information with the generated travel segment records via a unique user identifier 24 (discussed more below).

The user also uses the interface to manage both the user's customer profile and the generated travel records relating to the user's travel plans as well as access to the user record and information contained therein. For instance, the user can perform self management of data by updating travel requests and preferences and deciding what information different providers may view. Frequent flyer and other loyalty card numbers and information, stored within the customer profiles database, may be extracted and included in any travel segment record 34 that gives rewards for frequent flyer and loyalty members.

The providers include airlines, hotels, car rental companies, and other affiliates. The user record offers the providers a way to maximize customer relationship management, inventories management, revenue management, by allowing the providers to take advantage of always up-to-date (e.g., real time) information available from the user record.

The user record includes triggers 31, embedded in the individual travel segment records 34, that notify appropriate providers, via provider notice information 38, of new events including travel disruptions that may impact the customer's travel plans or present the providers with an opportunity to offer the customer an additional travel service or a change in the nature of the travel service.

For example, if travel segment record relating to an airline flight is updated to reflect a delayed arrival due to heavy snow at the destination airport, a trigger passes this information to the car rental company. The car rental company may check the travel record for the customer and see that the customer's current reservation is for a convertible or a high performance car. The car rental company can recognize that the current reservation may be inappropriate for the new weather conditions. The same information concerning late arrival can be provided to the hotel provider so that the hotel provider knows not to give the user's reserved room to someone else. However, when the flight is cancelled, the hotel provider knows the room is available to be reassigned to another guest without prejudice to the user who made the original room reservation.

Notified of the change weather condition, and recognizing the inappropriate nature of the current car reservation (inappropriate car type being reserved), the car rental company can suggest (by email, voicemail, text message, or other transmission) that the customer revise their reservation to a four wheel drive vehicle. Alternatively, the car rental company can make another suitable adjustment to the car reservation knowing the customer's vehicle preferences/requests.

The system allows the user to have control over access to the information in the user record. Information release authorizations 33 can be controlled by the user so that the user can control to whom the travel record information is released and to whom the triggers provide travel update information. In this way, the user controls each provider's content view 32. More specifically, the user controls what parts of each travel segment record each provider views when accessing the travel segment records within the user record. In this way, the views definition parts 37 may be used to define a different content view for each of plural providers so as to provide different viewing access rights, to the travel segment records, for each of the plural providers 40, where the views definition parts are derived from the information release authorization 33 stored in the user information storage area 23.

Additionally, the information release authorization 33 can be set to notify the user whenever any of the travel segment records have been modified by the providers by way of a user notification information 39. In this way, the providers are assured of automatic user notification of changes or upgrades in the travel segments which that provider controls. This saves the provider from being responsible for generating and sending a separate notification to the user.

For example if a aircraft problem forces an airline to change an airline flight departure time, the airline need only update the appropriate travel segment record and the system automatically sends the user a user notification information 39 in the form of a notice of the change in airline flight departure time. For another example, if a hotel provider has facility problems which prevent the hotel provider from having a reserved room available to give the user, the hotel provider may decide to upgrade the room or to find an alternative room with another provider. Such changes are made to the hotel travel segment record, and then the user is automatically notified. The user notification informations 39 can be by any conventional method including email, voice message, text message, printed notification, and internet, browser pop-ups.

The system comprises a user record for each user. Thus, there is one and only one user record per user. Each user is identified by a unique user identifier 24, e.g., user ID 24. Due to information release authorizations, each provider has their own view 32 of the user record, each view 32 being based on the information that has been authorized for release to that provider.

The user record comprises plural information parts 36 stored within the customer profiles database 30. A first type of information parts is data content parts. A personal information part comprises information such as the user's name, passport number, phone numbers, and address. A booking preferences part comprises information concerning airline seat preferences, preferred car rental companies at specific airports or in particular countries, and preferred hotel chains for individual cities. A payment data part comprises information on the user's credit cards including card types.

In addition to the data content parts such as the personal information part, the booking preferences part, and the payment data part, the use record also includes a second type of information parts, namely, views definition parts 37. The views definition parts define viewing access rights to the travel segment records for each provider contributing to the user record and are derived from the information release authorizations 33 made by the user.

The default view definition part for providers is to allow access (read/write access) to the travel segments in which that provider participates. For example, an airline would have read/write access to the airline travel segment records but not to hotel reservation travel segments. Of course, if the hotel provider is to be able to respond to travel segment changes, the hotel provider will be authorized to access the airline travel segment records and have triggers within the airline travel segment records send travel updates to the hotel. Similarly, a limousine service would have access to both incoming and outgoing flight information so that the limousine service could adjust to changes in both the incoming and outgoing flight times.

The travel agent that booked a customer's travel plan would normally have access to every travel segment record. Advantageously, the user can provide a custom view based on the granting of specific access rights on the individual elements of each travel segment record.

Within the user record and connected to the interface, there is a user information storage area 23 where the user can store and manage information, e.g., the information release authorizations 33. Additionally, personal requests such as a vegetarian meal on-board the airline flight can be attached to the airline travel segment record. If the hotel has access (a view 32) to the airline travel segment record, the hotel can use this information to offer the user vegetarian meals or to suggest area restaurants that cater to vegetarians.

Providers interface with the user record via the individual travel segment records 34 and from notice information 38 sent by a trigger 31 from a travel segment record 34 to a specific provider 40, e.g., the hotel provider or limousine provider being notified of a flight cancellation.

Providers can also read service information from travel segment records generated by other providers. This allows one type provider to be aware of services being offered by one provider so as to make appropriate enhanced service offers to the user. For example, the user can set the views definition parts 37 to allow hotel providers to view parts of the airline providers' generated travel segment records. The user defines, for the hotel providers, a first content view of travel segment records generated by the airline flight providers. This first content view may include read access, by the hotel providers, to dietary preferences of the user as expressed to the airline flight providers.

A hotel provider can read the travel segment records, generated by the airline flight providers, to determine the user's dietary preferences. The hotel provider can then make targeted meal offers to the user taking into account the user's dietary preference. The hotel provider accomplishes makes this offer by modifying hotel travel segment records (generated by the hotel provider) to include a meal offer to the user. The modification of the hotel travel record by the hotel provider generates a user notification information (39) that notifies the user of the meal offer.

This first content view may also include read access, by the hotel providers, to user special requests made to the airline flight providers. A hotel provider can thus read the airline flight travel segment records to determine the user has made any special requests to an airline. Special request information can be used to enhance the service the hotel provider offers to the user. For example, if the hotel provider determines, from reading the airline flight travel segment records, that the user requested a bassinet on-board the airline flight, the hotel provider can be prepared to have a baby's bed or cradle available as part of the user's hotel room reservation. If the user has made a request for a wheelchair on-board the airline flight, the hotel provider can be prepared to have a room that is wheelchair appropriate and have a wheelchair available when the user arrives at the hotel. Such proactive actions by the hotel provider can lead to both direct revenue increases as well as goodwill increases.

These above examples are only exemplary and are not intended to be limiting.

1. A customer-centric travel information management system, comprising:
a database (1) comprising plural user records (10), one user record dedicated to each user, each user being a different travel customer, each user record comprising
a user information storage area (23) configured to store i) information release authorizations (33), ii) personal request information, iii) information (39) input into the user information storage area for transmission to the user, and iv) a user identification (24) to uniquely identify the user record with a specific user,
a user interface (25) configured to input and output information between the user and the user information storage area,
a customer profiles database (30) including the user identification (24), data content parts (36) and views definition parts (37), and
plural travel segment records (34), each travel segment record including the user identification (24), travel segment data generated by a specific travel provider (40), a trigger (31) generating provider notice information (38) upon changes in the travel segment data, and a user notification information (39) section generating user notification information upon changes in the travel segment data being made by the specific travel provider.

2. The system of claim 1, wherein,
the views definition parts (37) define a different content view for each of plural providers in order to provide different viewing access rights, to the travel segment records, for each of the plural providers (40), and
the views definition parts are derived from the information release authorization (33) stored in the user information storage area (23).

3. The system of claim 2, wherein,
the data content parts comprise
a personal information part comprising information including a user name, a passport number, a phone number, and an address,
a booking preferences part comprising information on airline seat preferences, preferred car rental companies at specific airports, and preferred hotel chains for identified cities, and
a payment data part comprising credit card information.

4. The system of claim 1, wherein, the plural travel segment records (34) comprise flight, hotel, and car reservations.

5. The system of claim 1, wherein the trigger (31) issues the generated provider notice information (38) to a hotel provider upon changes in the travel segment data being made by a flight provider.

6. The system of claim 1, wherein the trigger (31) issues the generated provider notice information (38) to a car rental provider upon changes in the travel segment data being made by a flight provider, and receipt of the issued provider notice information by the car rental provider causes the car rental provider to offer a change in car type to the user.

7. The system of claim 1, wherein, the information release authorizations (33) are user-configurable to be set to notify the user, by generating the user notification information, whenever individual ones of the travel segment records have been provider-modified.

8. The system of claim 7, wherein, the user notification information is a notice of a change in an airline flight departure time.

9. The system of claim 1, wherein,
the views definition parts (37) define, for a hotel provider, a first content view of a first travel segment record generated by an airline flight provider,
the first content view including read access right for the hotel provider to read dietary preferences of the user from the first travel segment record,
reading the first travel segment record from the first content view, by the hotel provider, of the dietary preferences of the user provides a basis for the hotel provider modifying a second travel segment record generated by the hotel provider to include a meal offer to the user, and
modification of the second travel record by the hotel provider generates a user notification information (39) that notifies the user of the meal offer.

10. The system of claim 1, wherein,
the trigger (31) issues the generated provider notice information (38) to an airport restaurant provider upon a flight provider making flight departure time changes in the travel segment data of a flight travel segment record,
the generated provider notice information issued to the airport restaurant provider is a notice of a delay in a flight departure time, and
receipt of the generated provider notice information by the airport restaurant provider initiates a user notification information (39) that notifies the user of an airport meal offer at being made by the airport restaurant provider.

11. A customer-centric travel information management system, comprising:
a database (1) comprising plural user records (10), each user record dedicated to a different travel customer, each user record comprising
i) a customer profiles database (30) including a user identification (24), customer data content parts (36) and user-defined views definition parts (37), and
ii) plural travel segment records (34) created by different travel providers,
the customers profiles database linked to each of the plural travel segment records by the user identification,
each travel provider having read and write access rights to travel segment records created by that travel provider,
the user-defined views definition parts establishing each travel provider's read access rights to travel segment records not created by that travel provider,
wherein, the database creates a travel plan for the user based on the plural travel segment records.

12. The system of claim 11, wherein,
each travel segment record includes i) the user identification (24), ii) travel segment data written by the travel provider (40) creating that travel segment record, and iii) a trigger (31) generating provider notice information (38), to user-identified travel providers, upon changes in the travel segment data being made by the travel provider creating that travel segment record.

13. The system of claim 11, wherein, the user-defined views definition parts authorizes a first travel provider to read user preferences from travel segment records not created by the first travel provider.

14. The system of claim 11, wherein the user-defined views definition parts authorizes a hotel provider to read user requests recorded in an airline flight travel segment created by an airline flight provider.

15. A customer-centric travel information management system, comprising:
a database of travel user records connected to a computer network accessible by travel providers and travel users, each user record comprising
i) a customer profiles database (30) including a user identification (24) uniquely associated with each user and user-redefinable views definition parts (37), and
ii) plural travel segment records (34) individually linked, by the user identification, to the customer profiles database,
each travel segment record being created by a different one of plural travel providers,
the one travel provider having read and write access rights to the travel segment records created by the one travel provider,
the one travel provider having read access rights to travel segment records, created by travel providers other than the one travel provider, only to an extent authorized by the views definition parts,
wherein, the database creates a travel plan for the user based on the plural travel segment records.
